(19) United States
(12) Patent Application Publication
(10) Pub. No.: US 2005/0066728 A1
(43) Pub. Date: Mar. 31, 2005

(54) Z-axis angular rate micro electro-mechanical systems (MEMS) sensor

(75) Inventors: Eric P. Chojnacki, Dryden, NY (US); June P. Shen-Epstein, Freeville, NY (US); Nenad Nenadic, Ithaca, NY (US); Nathan L. Stirling, Dryden, NY (US); Vasile Nistor, Los Angeles, CA (US)

Correspondence Address: BROWN & MICHAELS, PC;400 M & T BANK BUILDING, 118 NORTH TIOGA ST, ITHACA, NY, 14850, US

(73) Assignee: Kionix, Inc., Ithaca, NY (US)

(21) Appl. No.: 10/891,755

(22) Filed: Jul. 15, 2004

Related U.S. Application Data
(60) Provisional application No. 60/505,991, filed on Sep. 25, 2003.

(51) Int. Cl. G01P 15/08

(52) U.S. Cl. 73/514.16

(57) ABSTRACT

An oscillatory angular rate MEMS sensor is described for sensing rotation about the “Z-axis”. Embodiments are either coupled-mass tuning-fork or single oscillating-mass in nature. The sensor includes mechanical and electrical function integration, and is preferably manufactured by a unique MEMS fabrication process.

### REFERENCE TO RELATED APPLICATIONS

This application claims an invention which was disclosed in Provisional Application No. 60/505,991 filed Sep. 25, 2003, entitled “Z-AXIS ANGULAR RATE MEMS SENSOR”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of microdevices and microstructures. More particularly, the invention pertains to MEMS angular rate sensors.

2. Description of Related Art

There is considerable interest in the development of low-cost, reliable, high-quality gyroscopic rate-of-rotation sensors enabled by developments in Micro Electro-Mechanical Systems (MEMS) technology. Traditional military-grade gyroscope fabrication techniques are not scalable to high-volume low-cost manufacturing. MEMS technology utilizes semiconductor fabrication techniques to construct microscopic electromechanical systems, and hence provides the manufacturing model for low-cost inertial sensing systems. A variety of researchers have pursued MEMS oscillatory rate gyroscope designs using a multiplicity of design and fabrication methods. All such designs, nevertheless, stem from fundamental oscillatory gyrodynamic principles, early embodied in U.S. Pat. No. 2,309,853 (Lyman et al.) and discussed in texts such as Gyrodynamics by R. N. Arnold and L. M. Maunder, Academic Press, §13.7, p. 369 (1961).

Rate sensors indicate rate of rotation about a stipulated Cartesian axis that is typically parallel to an axis of the sensor package. The terminology “Z-axis” refers to sensing along an axis normal to the package mounting plane, such as a printed circuit board, also referred to as a “yaw” rate sensor. This “Z-axis” is also typically normal to the plane of the silicon wafer in which a MEMS sensor is fabricated.

The dynamics of the sensor are primarily those of the classical coupled oscillators which have “symmetric” and “antisymmetric” resonant modes, as discussed in texts such as Classical Dynamics of Particles and Systems by J. B. Marion and S. T. Thornton, Harcourt College Publishers, 4^{th} ed., §12.2, p. 460 (1995). The Coriolis dynamics induced by superimposing rate of rotation to the system are described herein.

In its simplest form, an oscillatory rate gyroscope first drives a spring-mass system at its resonant frequency along a linear axis. For a drive force given by:
Fₓ(t)=F_{drive} sin(ωₓt), (1)
the position and velocity of the mass are described by:
xᵣₑₛ(t)=−δₓ cos(ωₓt) and (2)
\dot{x}ᵣₑₛ(t)=νₓ(t)=δₓωₓ sin(ωₓt), where (3)

$$\begin{matrix}{δ}_{x} = \frac{{Q}_{x} {F}_{drive}}{{k}_{x}} and & ( 4 ) \\ {ω}_{x} = \sqrt{{k}_{x} / m} . & ( 5 )\end{matrix}$$

δₓ is the resonant displacement amplitude along the x-axis, ωₓ is the resonant frequency along the x-axis, Qₓ is the resonator quality factor along the x-axis, kₓ is the linear spring constant along the x-axis, and m is the mass. When this oscillator is rotated about some axis with a rate \vec{Ω}, the Coriolis force as viewed in the rotating coordinate system is given by:
\vec{F}_{Coriolis}=−2m\vec{Ω}×\vec{ν}, (6)
which for \vec{Ω}=Ω_{z} and \vec{ν} given by eq. (3) becomes:
\vec{F}_{Coriolis}=F_{y}(t)=−2mΩ_{z}δₓωₓ sin(ωₓt). (7)
This Coriolis force then superimposes a y-motion upon the x-motion of the oscillating mass, or a suspended mass contained therein. The y-reaction motion is not necessarily at resonance, and its position is described by:
y(t)=A(ωₓ)sin [ωₓt+φ(ωₓ)], where (8)

$$\begin{matrix}A ( {ω}_{x} ) = \frac{2 {Ω}_{z} {δ}_{x} {ω}_{x}}{\sqrt{{( {ω}_{y}^{2} - {ω}_{x}^{2} )}^{2} + {( {ω}_{x} {ω}_{y} / {Q}_{y} )}^{2}}} {\to }^{{ω}_{y} \neq {ω}_{x }} \frac{{Ω}_{z} {δ}_{x}}{{ω}_{y} - {ω}_{x}} , & ( 9 ) \\ ϕ ( {ω}_{x} ) = atan ( \frac{{ω}_{x} {ω}_{y / {Q}_{y}}}{{ω}_{y}^{2} - {ω}_{x}^{2}} ) , and & ( 10 ) \\ {ω}_{y} = \sqrt{{k}_{y} / m} . & ( 11 )\end{matrix}$$

ω_{y} is the resonant frequency along the y-axis, Q_{y} is the resonator quality factor along the y-axis, and k_{y} is the linear spring constant along the y-axis. The Coriolis reaction along the y-axis has amplitude and phase given by eqs. (9) and (10) with a time variation the same as the driven x-motion, ωₓ. The time variation of rate-induced (Ω_{z}) Coriolis reaction being the same as driven x-motion allows the y-Coriolis motion to be distinguished from spurious motions, such as due to linear acceleration, using demodulation techniques analogous to AM radio or a lock-in amplifier. In this fashion, the electronic controls typically contained in an Application Specific Integrated Circuit (ASIC) sense and process dynamic signals to produce a filtered electronic output proportional to angular rate.

For a practical rate-sensing device, providing immunity to spurious accelerations beyond that of the aforementioned demodulation technique can be beneficial. A necessary embellishment of the rate sensing described in the previous paragraph is then to employ a second driven mass oscillating along the same linear x-axis, but π radians out of phase with the first. The second mass then reacts likewise to Coriolis force along the y-axis, but necessarily π radians out of phase with the first mass. The y-motions of the two masses can then be sensed in a configuration whereby simultaneous deflection of both masses in the same direction cancel as a common mode, such as due to acceleration, but the opposing Coriolis deflections add differentially. The two masses having driven x-oscillation π radians out of phase is referred to as “anti-phase” or “antisymmetrical” operation and the rate sensor classification is commonly referred to as a “tuning fork”.

The anti-phase motion described in the previous paragraph is one of the normal modes of classical coupled oscillators (210) shown in FIG. 1. If two proof masses of the same mass m₁ (200) are each connected to an anchor (203) by an identical spring of constant k₁ (201) with an interconnecting spring k₁₂ (202), where k₁₂<<k₁, then the first two normal modes of oscillation are given by:

$$\begin{matrix}{ω}_{symm} = \sqrt{{k}_{1} / {m}_{1}} , and & ( 12 ) \\ {ω}_{asymm} ≅ \sqrt{{k}_{1} + 2 {k}_{12} / {m}_{1}} . & ( 13 )\end{matrix}$$

The first mode ω_{symm} is the symmetrical mode wherein the two masses oscillate with the same positive or negative displacement at any given instant, thereby maintaining spring k₁₂ in its relaxed state at all times and k₁₂ has no contribution to the resonant frequency in eq. (12). The second mode ω_{asymm} is the antisymmetrical or anti-phase mode wherein the two masses oscillate with equal but opposite displacement at any given instant, thereby displacing spring k₁₂ twice as much as compared to the case of it being attached to one mass and anchored to a fixed object, giving rise to the factor of 2 in front of k₁₂ in eq. (13). It is this anti-phase resonant mode onto which electronics of the control system must lock for proper tuning-fork rate sensor operation.

MEMS rate sensors have numerous technical challenges related to fabrication technique, electrical wiring, complex system control, minute sense signals, thermal variation, and ever-present error signals. Therefore, there is a need in the art for a product that meets these challenges and is amenable to high-volume low-cost manufacturing.

### SUMMARY OF THE INVENTION

The invention is a planar oscillatory rate sensor utilizing either a single oscillator or two oscillators with coupling, with both embodiments having mechanical and electrical function integration. The embodiment having two oscillators with coupling further operates in “tuning fork,” or anti-phase type motion.

The sensor is preferably manufactured by a unique MEMS fabrication process. When a proof mass is vibrated along an in-plane x-axis and the substrate is rotated about an out-of-plane z-axis, the mass reacts due to the Coriolis force and oscillates in plane along the y-axis. Capacitive sensing and demodulation results in extraction of a rate-of-rotation signal from the Coriolis-induced y-motion. For the embodiment having two oscillators operated in anti-phase mode, the Coriolis-induced y-reaction is likewise anti-phase and differential sensing is utilized to extract a rate-of-rotation signal wherein acceleration signals are eliminated as common-mode.

The invention includes one or two proof masses suspended by a plurality of symmetric flexures connected to substrate anchor points. If two proof masses are utilized, there is also a flexure interconnecting the two proof masses with a much smaller spring constant than the main flexures of each proof mass, thus establishing a coupled oscillator system with an anti-phase normal mode.

Each proof mass includes a frame with an interior mass suspended by flexures which reacts as an accelerometer. The flexures from the substrate which are anchored to the frame are designed to flex preferentially along the x-axis driven oscillation, but resist flexure in orthogonal directions, preventing the frame from reacting to Coriolis y-axis force. The flexures from the frame to its interior accelerometer mass are conversely designed to flex preferentially along the y-axis to react to Coriolis force, but resist flexure in the frame's driven x-direction. The resonant frequency along the y-axis of each frame's interior accelerometer is preferably tuned separately from the frame's resonance along the x-axis such that it reacts to a desired extent to Coriolis force.

Actuation of the proof mass is preferably accomplished by capacitive comb drives. Sensing of the driven motion and the Coriolis rate motion is preferably accomplished by similar capacitive techniques. An electronic ASIC preferably provides necessary drive, sense, and signal processing functions to provide an output voltage proportional to rate.

The sensor has orthogonal x-, y-, and z-axes, for detecting a rate of rotation about the z-axis and includes a substrate; and a gross mass, symmetrical with respect to the x-axis and the y-axis, suspended from the substrate by a plurality of exterior anchor points. The gross mass includes at least one proof mass, symmetrical with respect to the x-axis and the y-axis, a driven frame surrounding each proof mass and attached to its proof mass and external anchor points by a plurality of flexures, a set of drive banks and a first set of sense banks for each driven frame for oscillating along the x-axis, a second set of sense banks attached to each proof mass for detecting Coriolis motion along the y-axis, and a plurality of electrode routing configurations connected to the set of drive banks and the first and second sets of sense banks.

At least part of the sensor is made by a trench isolation process including the steps of providing a substrate material, patterning the material with a first dielectric layer, etching the material to produce at least one isolation trench, filling the isolation trench with a second dielectric layer, planarizing the first and second dielectric layers, patterning and etching a via to expose the substrate for an electrical connection, depositing a metal layer into the via and onto the dielectric layers, patterning the metal layer to create the plurality of electrode routing configurations, and patterning, etching, passivating, and releasing a plurality of structural elements including the proof mass, each driven frame, and the flexures. In one embodiment of the present invention, the metal layer is made of aluminum.

One embodiment of the present invention has one proof mass.

A second embodiment of the present invention has two proof masses and a coupling spring between the two frames to allow frame motion predominantly along the x-axis in anti-phase motion such that Coriolis-induced anti-phase motion of the proof masses along the y-axis results.

The driven frames preferably have at least one electrical crossover element and at least one electrical isolation segment. The drive banks and sensor banks are preferably capacitive combs with each bank preferably including at least one electrical crossover element and at least one electrical isolation segment. The sensor preferably has a plurality of external bond pads electrically connected to the sensor by a plurality of current paths, where the current paths cross at a plurality of crossover points. The crossover points are preferably made by the trench isolation process. The sensor is preferably made from a single crystal silicon wafer, a silicon on insulator wafer, a polysilicon wafer, or an epitaxial wafer.

### BRIEF DESCRIPTION OF THE DRAWINGS

FIG. 1 shows a simplified diagram of a coupled two-mass oscillator.

FIG. 2 shows a schematic of the coupled-mass embodiment of the angular rate sensor of the present invention.

FIG. 3A shows a first phase of motion of the angular rate sensor of the present invention, where the proof masses are at an oscillation extreme of moving away from each other.

FIG. 3B shows a second phase of motion of the angular rate sensor of the present invention, where the proof masses are at a midpoint of oscillation, with all flexures in a relaxed state.

FIG. 3C shows a third phase of motion of the angular rate sensor of the present invention, where the proof masses are at an oscillation extreme of moving towards each other.

FIG. 4 shows a simplified embodiment of the present invention which contains a single proof mass.

FIG. 5A shows the first step of a preferred fabrication sequence for the present invention.

FIG. 5B shows the second step of a preferred fabrication sequence for the present invention.

FIG. 5C shows the third step of a preferred fabrication sequence for the present invention.

FIG. 5D shows the fourth step of a preferred fabrication sequence for the present invention.

FIG. 5E shows the fifth step of a preferred fabrication sequence for the present invention.

FIG. 5F shows the sixth step of a preferred fabrication sequence for the present invention.

FIG. 5G shows the seventh step of a preferred fabrication sequence for the present invention.

FIG. 5H shows the eighth step of a preferred fabrication sequence for the present invention.

FIG. 6A shows the structures of the invention which perform the crossover function of a multi-level metallization.

FIG. 6B shows examples of the locations of crossover elements in an embodiment of the present invention.

FIG. 7 shows a diagram of a crossover implemented in the structure of an embodiment of the rate-sensing MEMS device.

### DETAILED DESCRIPTION OF THE INVENTION

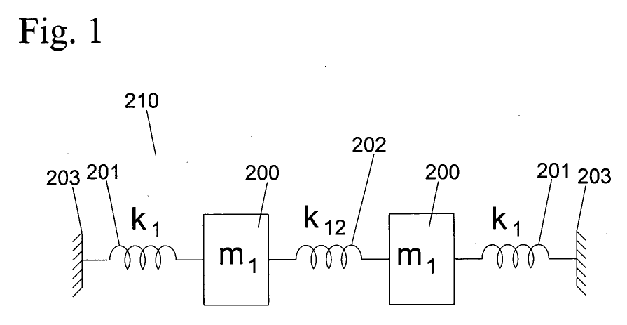

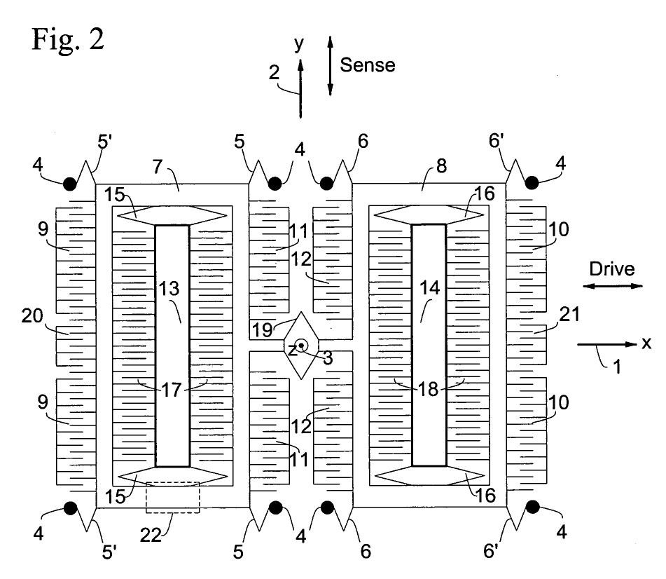

The present invention discloses a novel rate sensor design and system integration. In the first embodiment, the coupled-mass mechanical oscillator (210), shown schematically in FIG. 1, is realized with the necessary electrostatic drive and sense wiring to create the rate sensor of FIG. 2 by a novel fabrication process. The rate sensor is preferably fabricated using the methods taught in U.S. Pat. Nos. 6,239,473 (Adams et al.) and 6,342,430 (Adams et al.) assigned to an assignee of the present invention. These patents are hereby incorporated herein by reference. The fabrication process permits unique electrical isolation that allows released silicon beams to be electrically isolated but mechanically linked to other released beams and wafer substrates. Further, unique electrical “crossover” elements are also made possible whereby two mechanically intersecting and intact released silicon beams can propagate one electrical signal along the direction of one of the beams within the silicon, and a separate electrical signal can be propagated along the direction of the second beam atop the beams by an insulated metal layer. Such electrical crossovers allow significant design latitude to achieve optimal mechanical linkages while accommodating the necessary electrical networks integral to the mechanical structure. A description of the fabrication methods and implementation in the MEMS device follows the descriptions of the structural embodiments and mechanics.

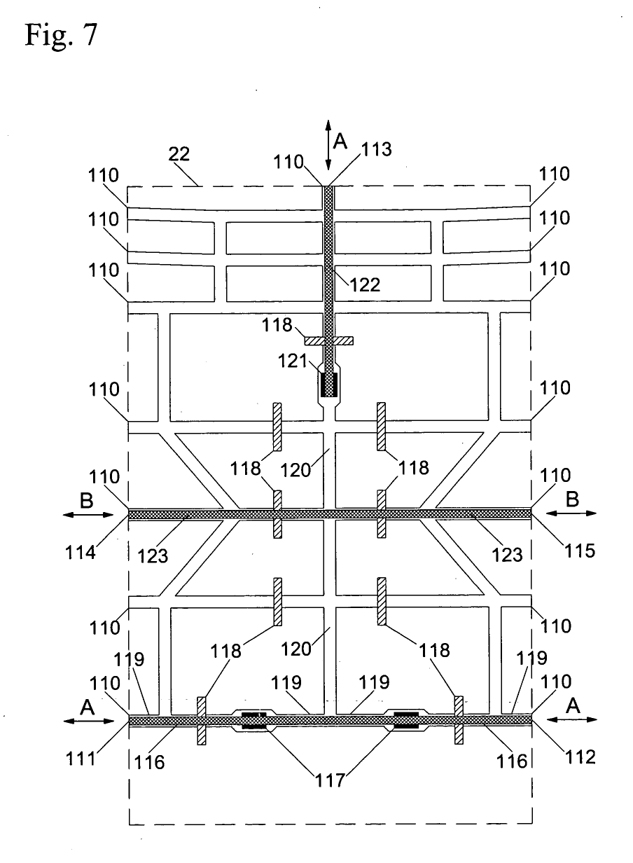

Referring to FIG. 2, a first embodiment of the angular rate sensor of the present invention is symmetric about the x-axis (1) and y-axis (2) of the device. The x-axis (1) is the axis of driven anti-phase proof-mass oscillation and the y-axis (2) is the axis of Coriolis-induced oscillation when the sensor is rotated about the z-axis (3). The released structure has anchor points (4) to the substrate generally exterior to the structure. One set of flexures (5) and (5′) connect a first proof mass frame (7) to substrate anchor points (4) and a second set of flexures (6) and (6′) connect a second proof mass frame (8) to substrate anchor points (4). The specific linkages of the trusswork vary depending upon a number of factors including, but not limited to, desired electrical routing and overall beam stiffness. One example of a small portion of the trusswork (22) of the first proof mass (7) appears in detail in FIG. 7, and shows the crossover elements. The flexures (5/5′) and (6/6′) are designed to be compliant along the x-axis (1), but much stiffer along the y-axis (2) and z-axis (3). Flexures are depicted as folded springs throughout the figures, but other structures, such as straight, thin beams, right angle springs, or multiple folds, are within the spirit of the present invention. A flexure (19) interconnects the two proof mass frames (7) and (8) to provide weak coupling between the two proof mass frames. This flexure (19) preferably has a much lower spring constant than the flexures (5/5′) and (6/6′) connecting the proof mass frames (7) and (8) to substrate anchor points (4).

Anti-phase oscillation of the coupled frames (7) and (8) and their interior structures is electrostatically driven by capacitive comb drives (9) and (10), and (11) and (12), respectively. Alternatively, the use of piezoelectric or magnetic actuating elements is within the spirit of the present invention. One set of drive banks (9) and (10) pull the frames (7) and (8) away from each other, while a second set of drive banks (11) and (12) pull the frames (7) and (8) toward each other. The drive banks (9) and (10) or (11) and (12) are alternately energized at the coupled-frame anti-phase resonant frequency. A first set of sense electrodes (20) and (21) capacitively senses this driven motion of the frames (7) and (8) for use in electronic monitoring of driven motion amplitude.

Within the frames (7) and (8), accelerometer proof masses (13) and (14) are suspended by flexures (15) and (16). These flexures (15) and (16) are designed to be compliant along the y-axis (2), but much stiffer along the x-axis (1) and z-axis (3). Proof masses (13) and (14) then perform anti-phase motion along the x-axis (1) along with frames (7) and (8). Upon rotation of the entire device about the z-axis (3), the Coriolis force acts along the y-axis (2) upon the proof masses (13) and (14), but in opposite directions for each due to their anti-phase motion along the x-axis (1), as described by eqs. (3) and (8) above where there is a π-radian phase difference between sine terms for the proof masses (13) and (14). The frames (7) and (8) likewise experience anti-phase Coriolis forces along the y-axis (2), but the lack of compliance of the flexures (5/5′) and (6/6′) along the y-axis (2) keeps such Coriolis-induced motion at negligible levels.

The Coriolis-induced anti-phase motion along the y-axis of the proof masses (13) and (14) is sensed electrostatically by a second set of sense capacitive combs (17) and (18). The capacitive comb banks (17) and (18) are electrically wired such that motion of the proof masses (13) and (14) along the y-axis (2) with the same phase is sensed as a common-mode between comb banks (17) and (18), but motion of the proof masses (13) and (14) along the y-axis (2) with anti-phase is sensed differentially between the comb banks (17) and (18) and converted to a rate signal by an ASIC. Small y-axis (2) motion of the frames (7) and (8), as reaction to Coriolis forces, reduces sensed motion of the proof masses (13) and (14), since the proof mass motion is sensed relative to the frame motion. Such Coriolis-induced y-axis (2) motion of frames (7) and (8) is typically negligible compared to proof mass (13) and (14) Coriolis-induced motion.

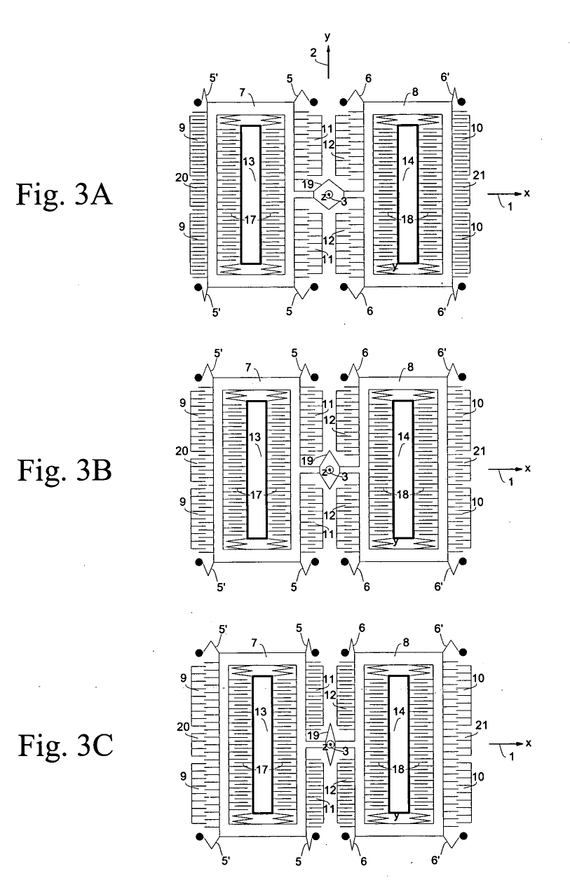

FIGS. 3A through 3C illustrate the above-described anti-phase motion of the proof masses as a series of three phases within a continuous oscillation cycle. In FIG. 3A the proof masses are at an oscillation extreme of moving away from each other. Flexures (5), (6) and (19) are now extended, while flexures (5′) and (6′) are compressed. At this instant, the drive banks (9) and (10) are transitioning from being energized to pull the frames (7) and (8) away from each other to being unenergized and exerting no force on frames (7) and (8). Conversely, drive banks (11) and (12) are transitioning from being unenergized and exerting no force on frames (7) and (8) to being energized to pull frames (7) and (8) away toward each other. The x-axis (1) velocity of the proof masses (13) and (14) and frames (7) and (8) described by eq. (3) is zero at this time of displacement extreme described by eq. (2), and for non-resonant operation, the Coriolis y-axis (2) displacement of proof masses (13) and (14) described by eq. (8) is also zero. The capacitive sense banks (17) and (18) are each internally balanced at this instant of zero Coriolis y-axis (2) displacement of the proof masses (13) and (14).

In FIG. 3B, the proof masses (13) and (14) are at a midpoint of oscillation. All of the flexures (5/5′), (6/6′), and (19) are in a relaxed state. The x-axis (1) velocity of the proof masses (13) and (14) and frames (7) and (8), described by eq. (3), is maximum at this time of zero displacement described by eq. (2), and for non-resonant operation, the Coriolis y-axis (2) displacement of proof masses (13) and (14) described by eq. (8) is also at a maximum. The capacitive sense banks (17) and (18) are each internally maximally imbalanced at this instant of maximum Coriolis y-axis (2) displacement of the proof masses (13) and (14).

In FIG. 3C the proof masses are at an oscillation extreme of moving toward each other. The flexures (5), (6), and (19) between the frames (7) and (8) are now compressed, while the external flexures (5′) and (6′) are extended. The phase of oscillation shown in FIG. 3C has a π-radian difference from the phase shown in FIG. 3A. The x-axis (1) velocity of the proof masses (13) and (14) and frames (7) and (8) described by eq. (3) is zero at this time of displacement extreme described by eq. (2), and for non-resonant operation, the Coriolis y-axis (2) displacement of proof masses (13) and (14) described by eq. (8) is also zero. The capacitive sense banks (17) and (18) are each internally balanced at this instant of zero Coriolis y-axis (2) displacement of the proof masses (13) and (14).

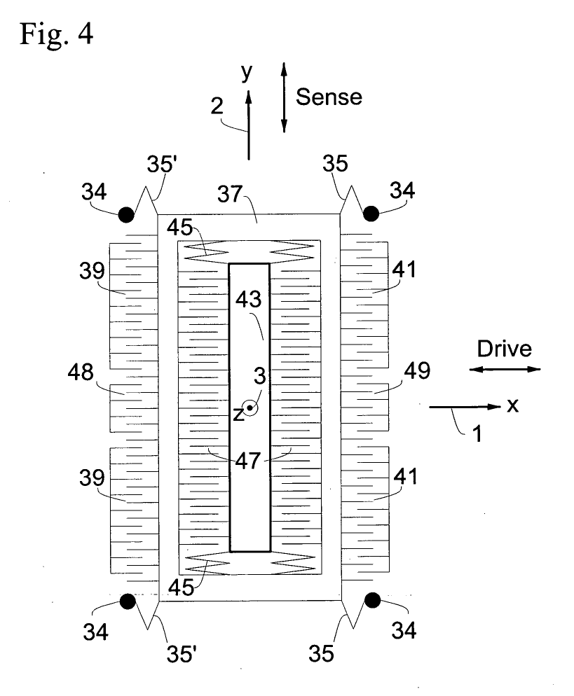

FIG. 4 shows a second embodiment of the present invention, which contains a single oscillating proof-mass. The lack of a second coupled proof mass in FIG. 4 precludes common-mode cancellation of spurious acceleration. Such a simplified sensor has a lower manufacturing cost by virtue of less die area, suitable for applications requiring less-stringent rate and acceleration performance. The embodiment in FIG. 4 is symmetric about the x-axis (1) and y-axis (2) of the device. The x-axis (1) is the axis of driven proof-mass oscillation and the y-axis (2) is the axis of Coriolis-induced oscillation when the sensor is rotated about the z-axis (3). The released structure has anchor points (34) to the substrate generally exterior to the structure. A set of flexures (35) and (35′) connect a proof mass frame (37) to substrate anchor points (34). The flexures (35) and (35′) are designed to be compliant along the x-axis (1), but much stiffer along the y-axis (2) and z-axis (3).

Oscillation of the frame (37) and its interior structure is electrostatically driven by capacitive comb drives (39) and (41). One drive bank (39) pulls the frame (37) along the negative x-axis (1), and the other drive bank (41) pulls the frame (37) along the positive x-axis (1). The drive banks (39) and (41) are alternately energized at the frame (37) resonant frequency. A square wave is applied to each, with the square waves preferably π radians out of phase. A first set of sense electrodes (48) and (49) capacitively senses this driven motion of the frame (37) for use in electronic monitoring of driven motion amplitude.

Within the frame (37) an accelerometer proof mass (43) is suspended by flexures (45). These flexures (45) are designed to be compliant along the y-axis (2), but much stiffer along the x-axis (1) and z-axis (3). The proof mass (43) then performs motion along the x-axis (1) along with the frame (37). Upon rotation of the entire device about the z-axis (3), the Coriolis force acts along the y-axis (2) upon the proof mass (43) as described by eqs. (3) and (8) above. The frame (37) likewise experiences Coriolis force along the y-axis (2), but the lack of compliance of the anchoring flexures (35) and (35′) along the y-axis (2) keeps such Coriolis-induced motion at negligible levels.

The Coriolis-induced motion along the y-axis of proof mass (43) is sensed electrostatically by a second set of sense capacitive combs (47) and is converted to a rate signal by an ASIC. Small y-axis (2) motion of the frame (37) as reaction to Coriolis forces reduces sensed motion of the proof mass (43), since the proof mass motion is sensed relative to the frame motion. Such Coriolis-induced y-axis (2) motion of the frame (37) is typically negligible compared to proof mass (43) Coriolis-induced motion.

Specific aspect ratios of beam widths and heights vary depending upon fabrication media and mode tuning. For example, if a device of this invention has a frequency separation as defined in eqs. (5) and (11) of ω_{y}−ωₓ=2π*500 Hz (non x-y resonant operation) and a driven amplitude along the x-axis as defined in eq. (4) of δₓ=10 μm, the Coriolis displacement along the y-axis as defined in eq. (9) for an input rotation rate of Ω_{z}=100°/s is 5.4 nm for the proof masses.

The preferred fabrication sequence for the silicon gyroscope utilizes a silicon micromechanical fabrication process. The process results in a rate sensor composed of a trusswork of tall, thin silicon beams with integral electrical isolation segments, which serve to connect mechanically but isolate electrically separate parts of the rate sensor. The unique MEMS fabrication process exploiting electrical isolation and crossover technology enables layout conveniences and die area efficiency, as well as indiscriminant differential sensing of variable capacitors throughout the device geometry. This fabrication process is hereby referred to as the trench isolation process for the purposes of the present disclosure.

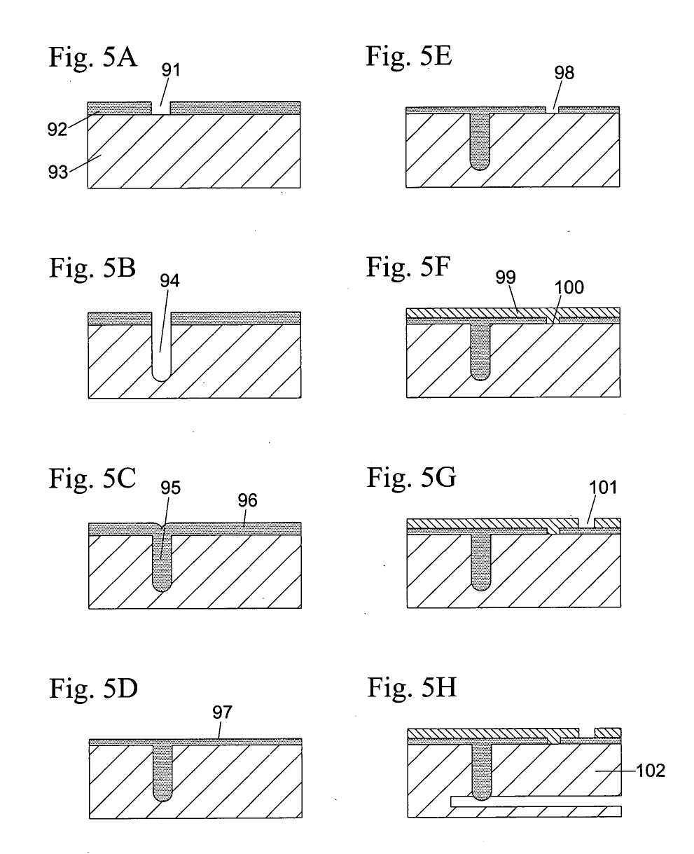

The trench isolation process is detailed in U.S. Pat. No. 6,239,473 and depicted in FIGS. 5A through 5H. In the first step, shown in FIG. 5A, the process begins with a substrate or wafer (93), which is preferably made of silicon, with a dielectric layer (92) patterned (91) with conventional techniques. In step 2, shown in FIG. 5B, the wafer (93) is etched to produce an isolation trench (94). In step 3, shown in FIG. 5C, the trench is filled (95) with a dielectric layer (96). In step 4, shown in FIG. 5D, the dielectric layer (96) and filled trench (95) are planarized to provide a smooth dielectric surface (97) with an integral electrically isolating dielectric segment. In step 5, shown in FIG. 5E, a via (98) in the dielectric (97) is patterned and etched to expose the surface of the silicon (93) for electrical connection. In step 6, shown in FIG. 5F, a metal layer (99) is deposited on the dielectric layer (97) and makes contact through the via (98) at the silicon surface (100). In step 7, shown in FIG. 5G, the metal (99) is patterned (101) to create different electrode routing configurations. In one embodiment, the metal layer (99) is made of aluminum, but alternative materials are also embodied by the present invention. In step 8, shown in FIG. 5H, the beams (102), preferably made of silicon, are patterned, etched, passivated, and released to provide free-standing cantilevers for micromechanical elements. All of the MEMS structure is preferably made of the same building-block beams, which are trussed together in different configurations to make, for example, the stiff frames or the flexures.

The trench isolation process offers several distinct advantages that permit the rate sensor to function and operate at high performance levels. The high aspect, single crystal silicon beams allow the rate sensor to be built as a trusswork over millimeter-scale diameters, large by conventional micromachining standards. In different embodiments, various linkage configurations of the trusswork are implemented to yield stiff larger-scale beams or thin flexures. This permits the rate sensor to obtain large inertial mass, resulting in high sensitivity and high resolution. A metal conductive layer is present on the top of the beam structures only, providing multiple structural connections such as are required for comb drive and sense. Isolation segments are incorporated into the silicon beams, reducing parasitic capacitance and electrically decoupling the different functions of the rate sensor. In regions where capacitive comb actuation or sensing is required, the metal layer contacts the beam silicon cores, which serve as the capacitor plates. This is allowed because the isolation segments interrupt the conduction path from the silicon beams to the substrate silicon. Finally, in areas which require electrical paths to cross each other in order to address different active sections of the rate sensor, a multi-level conduction path is possible using the top conductive metal layers and the contacts to the underlying silicon. The process thus allows each of the functionalities required in the rate sensor and performs them in a highly manufacturable environment with standard silicon substrates.

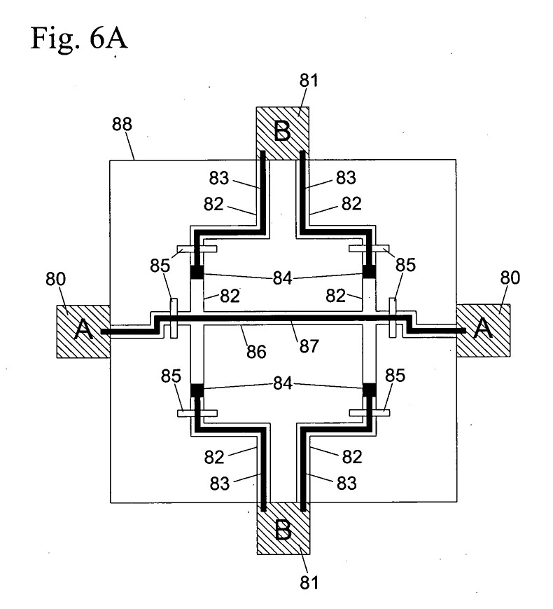

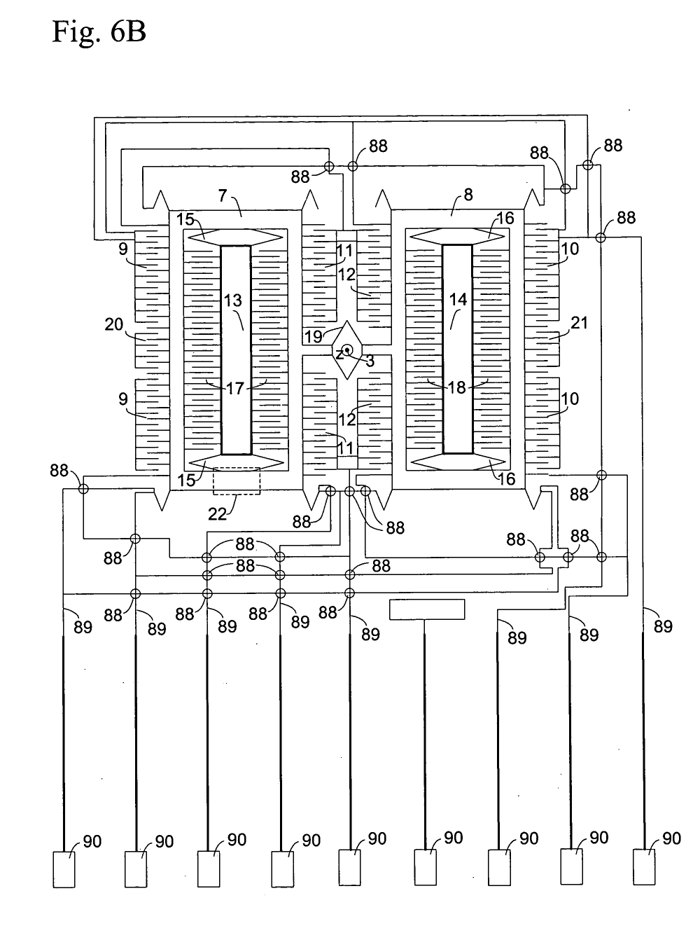

An important byproduct of the trench isolation process is the ability to create electrical interconnect structures which perform a crossover function of a multi-level metallization. One such crossover is described in U.S. Pat. No. 6,626,039 (Adams et al.) and is shown in FIG. 6A, as it is practiced within the present rate sensor design. This patent is hereby incorporated herein by reference. In FIG. 6A, a cavity (88) contains simple released crossing silicon beams (82) and (86). Signal A (80) is routed across one beam structure (86) using only the planar metal layer (87) which is insulated from the beam (86) by an intermediate oxide layer. Signal B (81) is routed perpendicular to signal A (80) using a path through the silicon beams (82) themselves. The current path for B travels within the planar metal layer (83), which is insulated from the beam (82) by an intermediate oxide layer. The path connects to the silicon through the contact vias (84), and the current flows through the double silicon beams (82) to the opposing vias (84) and out the metal path (83). In this way, the B current travels beneath and is isolated from the A current, creating a multiple-level current path without the need for the traditional two metal layers. In order that the silicon conduction path for B be isolated from the rest of the silicon substrate, electrical isolation segments (85) are strategically placed within the design. The result is a multiple level interconnect scheme using only one planar metal layer, an insulating oxide layer, and the conduction of the silicon beam cores.

A crossover as shown in FIG. 6A can be implemented external to the region of a released MEMS mechanical structure for use in routing signals from bond pads to the mechanical structure. An example of the external locations of these crossovers is shown in FIG. 6B. The crossovers (88) are used where two separated current paths (89) cross. Some of the bond pads (90) are also shown. The network of signals shown in FIG. 6B is a representative example of one embodiment of the present invention; other networks are within the spirit of the present invention.

The crossovers are also preferably utilized interior to the mechanical structure. FIG. 7 shows the details of an example of a section of trusswork (22) included in the moving frame (7) of FIG. 2, where an electrical crossover is utilized within the trusswork (22). This section connects to the rest of the movable structure at a series of points (110). The purpose of the crossover is to “T off” signal A as its runs horizontally from a first point (111) to a second point (112) such that it also runs vertically to a third point (113), the vertical run being across signal B that runs horizontally from one point (114) to a second point (115). The electrical path for signal A starts at the first point (111) on a metal trace (116) that continues through to the second point (112). The metal trace (116) runs on top of a beam (119) and also connects to vias (117), where signal A enters the silicon beam. All silicon electrical paths starting at the vias (117) are isolated from the surrounding silicon connections (11 0) by isolation joints (118). Signal A at the vias (117) travels through the beams (119) and (120) to a via (121). At the via (121), signal A enters a metal trace (122) and travels to the third point (113), where it continues to other regions within the movable structure. Signal B starts at a point (114) on a metal trace (123) and travels straight from the point (114) to a second point (115), where it continues to other regions within the movable structure. By implementing a plurality of crossovers in the manner described, the unique MEMS fabrication process enables layout convenience, die area reduction, and indiscriminate differential sensing of variable capacitors throughout the device geometry.

It is also noted that the formation of isolation segments and crossovers is not limited to single-crystal silicon, but also applies to thick-film polysilicon, epitaxial silicon, and silicon-on-insulator geometries.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A sensor, having orthogonal x-, y-, and z-axes, for detecting a rate of rotation about the z-axis comprising:
a substrate; and
a gross mass, symmetrical with respect to the x-axis and the y-axis, suspended from the substrate by a plurality of exterior anchor points, and comprising;
at least one proof mass, symmetrical with respect to the x-axis and the y-axis;
a driven frame surrounding each proof mass and attached to its proof mass and external anchor points by a plurality of flexures;
a set of drive banks and a first set of sense banks for each driven frame for oscillating along the x-axis;
a second set of sense banks attached to each proof mass for detecting Coriolis motion along the y-axis; and
a plurality of electrode routing configurations connected to the set of drive banks and the first and second sets of sense banks;
wherein at least part of the sensor is made by a trench isolation process comprising the steps of:
a) providing a material;
b) patterning the material with a first dielectric layer;
c) etching the material to produce at least one isolation trench;
d) filling the isolation trench with a second dielectric layer;
e) planarizing the first and second dielectric layers;
f) patterning and etching a via to expose the substrate for an electrical connection;
g) depositing a metal layer into the via and onto the dielectric layers;
h) patterning the metal layer to create the plurality of electrode routing configurations; and
i) patterning, etching, passivating, and releasing a plurality of structural elements including the proof mass, each driven frame, and the flexures.

2. The sensor of claim 1, wherein the gross mass comprises one proof mass.

3. The sensor of claim 1, wherein the gross mass further comprises two proof masses, two driven frames, and a coupling spring between the two driven frames to allow frame motion predominantly along the x-axis in anti-phase motion such that Coriolis-induced anti-phase motion of the proof masses along the y-axis results.

4. The sensor of claim 1, wherein the metal layer comprises aluminum.

5. The sensor of claim 1, wherein at least one driven frame comprises at least one electrical crossover element and at least one electrical isolation segment.

6. The sensor of claim 1, wherein each drive bank and each sensor bank is a capacitive comb.

7. The sensor of claim 1 further comprising a plurality of external bond pads electrically connected to the sensor by a plurality of current paths, wherein the current paths cross at a plurality of crossover points.

8. The sensor of claim 7, wherein at least one crossover point is made by the trench isolation process.

9. The sensor of claim 1, wherein the material is selected from the group consisting of:
a) a single crystal silicon wafer;
b) a silicon on insulator wafer;
c) a polysilicon wafer; and
d) an epitaxial wafer.
